(19) United States
(12) Patent Application Publication
(10) Pub. No.: US 2019/0358738 A1
(43) Pub. Date: Nov. 28, 2019

(54) Laser Pressure Welding

(71) Applicant: CSM Maschinen GmbH, Landsberg am Lech (DE)

(72) Inventors: Helmut Schuster, Denklingen (DE); Robert Merk, Lamerdingen (DE); Andreas Petzuch, Augsburg (DE); Florian Hormann, Altomunster (DE)

(73) Assignee: CSM Maschinen GmbH, Landsberg am Lech (DE)

(21) Appl. No.: 16/461,784

(22) PCT Filed: Nov. 15, 2017
(86) PCT No.: PCT/EP2017/079336

§ 371 Date: May 16, 2019

(30) Foreign Application Priority Data
Nov. 16, 2016 (DE) 10 2016 122 060.4

(51) Int. Cl. B23K 20/00; B23K 20/02; B23K 26/26; B23K 26/28; B23K 26/06; B23K 26/08; B23K 35/02

(52) U.S. Cl. CPC B23K 20/008; B23K 20/02; B23K 26/26; B23K 35/0255; B23K 26/0604; B23K 26/0876; B23K 26/28

(57) ABSTRACT

The present invention discloses laser pressure welding which is used for joining a first metal component with a second metal component; the first metal component has a first joining section with a first joining surface; the second metal component has a second joining section with a second joining surface; laser beams are projected onto the first and second joining sections of the first and second metal components to heat the first and second joining surfaces to a temperature between their re-crystallization temperature and melting temperature respectively; and the first joining surface of the first metal component is pressed tightly against the second joining surface of the second metal component until the first joining and second joining surfaces are cooled to a temperature below their re-crystallization temperature.

### BACKGROUND OF THE INVENTION

### (a) Field of the Invention

The present invention relates to the technical field of laser pressure welding, and more particularly to a laser pressure welding method that connects a first metal component having a first joining surface with a second metal component having a second joining surface, and an apparatus used in the method, and a work piece manufactured by the laser pressure welding method.

### (b) Description of the Prior Art

German Patent Publication No. DE 10 2008 014 934 A1 discloses a method that connects a first metal component having a first joining surface with a second metal component having a second joining surface, and heats the first joining surface and the second joining surface by magnetic field to a temperature between the re-crystallization temperature and the melting temperature of the first and second metal components, and then presses the first and second metal components against each other until the first and second joining surfaces of the first and second metal components are cooled to a temperature below their re-crystallization temperatures respectively.

### SUMMARY OF THE INVENTION

It is a primary objective of the present invention to overcome the aforementioned drawbacks of the conventional method.

To achieve the aforementioned and other objectives, the present invention provides a method for joining a first metal component together with a second metal component, wherein the first metal component has a first joining section with a first joining surface, and the second metal component has a second joining section with a second joining surface, and the method includes the steps of: projecting a first laser beam onto the first joining section of the first metal component to heat the first joining surface to a temperature between the re-crystallization temperature and the melting temperature of the first metal component; projecting a second laser beam onto the second joining section of the second metal component to heat the second joining surface to a temperature between the re-crystallization temperature and the melting temperature of the second metal component, and pressing the first joining surface of the first metal component against the second joining surface of the second metal component tightly until the first joining surface of the first metal component and the second joining surface of the second metal component are cooled to their re-crystallization temperatures respectively.

In the prior art as described above, the first joining surface of the first metal component and the second joining surface of the second metal component are heated by a magnetic field. Due to the mutual effect of the magnetic fields, the materials used for making the first joining surface of the first metal component and the second joining surface of the second metal component cannot be selected freely due to the interference of the magnetic field. Therefore, the first metal component and the second metal component must be made of materials having substantially the same re-crystallization temperature and melting temperature for pressure welding by magnetic effects. The same problem is more obvious in the pressure welding that uses friction for heating since the temperature produced by the friction of the first joining surface of the first metal component and the second joining surface of the second metal component cannot be controlled or adjusted freely. In addition, another drawback of the aforementioned two methods is that the geometric shape of the joining surface is limited. In the welding that uses friction for heating, the joining surface must be closed and as flat as possible and cannot be disposed in the cavities of the first metal component and the second metal component, otherwise the first metal component and the second metal component cannot be heated at the first joining surface and the second joining surface respectively.

In the basic principle of the present invention, laser beam is used to replace the conventional pressure welding methods for the heating in the pressure welding process, so that the first joining surface of the first metal component and the second joining surface of the second metal component of any shape can be heated easily. Since laser beam is like a pen, it can reach most concave surfaces and partially broken contours. The energy inputted by the laser beam to the first joining surface of the first metal component and the second joining surface of the second metal component can be adjusted without mutual interference. Therefore, this method allows the first metal component and the second metal component of different re-crystallization temperatures to be joined together. For example, aluminum with a re-crystallization temperature of 150° C. and nickel with a re-crystallization temperature of 600° C. can be joined together by the method of the present invention, but cannot, by the conventional pressure welding methods.

In addition to the first joining surface of the first joining section and the second joining surface of the second joining section, other surfaces of the first metal component and the second metal component can be irradiated by a laser beam so that first joining surface and the second joining surface can be heated, and the precondition is that heated surface is arranged to be as close as possible to the first joining section and the second joining section to ensure that the heat energy can be transferred to the heated surface. Therefore, the heated surface can be heated by the projection of the laser beam directly or can be heated by the projection of the laser beam through its adjacent surface indirectly.

Basically, a same laser beam can be used to heat both of the first joining section of the first metal component and the second joining section of the second metal component. However, in order to minimize any energy loss caused by the cooling of the first joining surface of the first metal component and the second joining surface of the second metal component, each of the first joining section and the second joining section should be projected by a respective laser beam individually. It is necessary to take a higher equipment cost into consideration for the use of a second laser beam, but the use of two laser beams for the work can synchronously reduce the energy loss caused by cooling. As time moves on, the energy loss can be reduced considerably.

According to an improvement of the present invention, the first joining surface and the second joining surface are projected by the first laser beam and the second laser beam respectively, wherein the surface normal of the first beam surface and the surface normal of the second beam surface are opposite to each other. With this arrangement, it is not necessary to turn the first metal component and the second metal component in opposite directions after they are heated to a temperature greater than the re-crystallization temperature. This arrangement not just omits the actuator required for the turning only, but also avoids increasing the cooling time caused by the turning and thus lower the energy cost.

According to a special improvement of the present invention, when the first laser beam and the second laser beam are projected onto the first joining surface and the second joining surface respectively, a specific angle is defined between the first laser beam and the surface normal of the first joining surface, and a specific angle is defined between the second laser beam and the surface normal of the second joining surface. In the heating process, the first joining surface and the second joining surface are aligned with the same axis, and these two joining surfaces after heating can be pressed against by moving them along the axis, so as to shorten the moving path of the first metal component and the second metal component required for the pressing process and minimize the energy loss caused by cooling.

According to another improvement of the present invention, the first and second laser beams with a predetermined intensity are projected onto the corresponding first and second joining sections along a curved path thereon. By this method, the first joining section and the second joining section are as if they are painted by a pen and effectively heated by the laser beam to a working temperature required for the pressure welding.

Here, the laser beams move not only once, but move along the curved path with an energy superimposition frequency periodically, so as to avoid a too-long residence time of the laser beams at a portion of the corresponding joining sections that may lead to partially damages of the corresponding metal components caused by overheat by a temperature above the melting temperature of the corresponding metal components.

The selection of the aforementioned energy superimposition frequency should satisfy the following conditions. Each of the heated point on the curved path has an energy gain during a heating stage and an energy loss during a cooling stage, wherein the energy gain must be greater than the energy loss so that the total energy gain is sufficient to heat the corresponding joining section to a temperature greater than the re-crystallization temperature. The heated point is in the heating stage when the corresponding laser beam is projected thereon, and otherwise the heated point is in the cooling stage.

If the materials used for manufacturing the first metal component and the second metal component are different, then it will need to select different parameters such as energy superimposition frequency, laser beam intensity, or other parameters.

According to another aspect of the present invention, an apparatus is designed and manufactured to implement the aforementioned technical process. The apparatus includes a first chuck, for clamping the first metal component; a second chuck, for clamping the second metal component; a laser beam generator, for generating a laser beam to heat the first joining surface of the first metal component and the second joining surface of the second metal component; a pressure equipment, for holding and pressing the first metal component with the heated first joining surface against the second metal component with the heated joining surface tightly.

According to another aspect of the present invention, a workpiece is provided. The workpiece includes the first metal component, made of a first material, and having a first joining surface; the second metal component, made of a second material which is different from the first material, and having a second joining surface; wherein the first joining surface and the second joining surface are pressed tightly against each other by the aforementioned method.

For example, the workpiece is a drill bit, wherein the first metal component is a drill bit top, and the second metal component is a drill bit thread. The drill bit thread and the drill bit top are not just manufactured by completely different manufacturing technologies by batch production and then connected with each other only, but the selection of materials for making them is not limited. For example, a very hard sintered material is selected for making the drill bit top, and a material suitable for simple cutting is selected for making the drill bit thread.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 is a schematic view of a production line in accordance with an embodiment of the present invention;

FIG. 2 is a perspective view of a laser pressure welding machine used in the production line as depicted in FIG. 1;

FIG. 3 is a blowup view of the laser pressure welding machine as depicted in FIG. 2;

FIG. 4A is a schematic view showing a workflow of the laser pressure welding machine as depicted in FIGS. 2 and 3 in accordance with a first embodiment of the present invention;

FIG. 4A′ is a schematic view showing a burr formed between the first metal component and the second metal component as depicted in FIG. 4A after pressure welding;

FIG. 4B is a schematic view showing a path of a laser beam of the laser pressure welding machine as depicted in FIGS. 2 and 3 projected onto the first metal component;

FIG. 4C is a schematic view showing that the energy of the first metal component as depicted in FIG. 4B changes with time;

FIG. 5A is a schematic view showing the workflow of the laser pressure welding machine as depicted in FIGS. 2 and 3 in accordance with a second embodiment of the present invention;

FIG. 5A′ is a schematic view showing a burr formed between the first metal component and the second metal component as depicted in FIG. 5A after pressure welding;

FIG. 5B is a schematic view showing the workflow of the laser pressure welding machine as depicted in FIGS. 2 and 3 in accordance with a third embodiment of the present invention;

FIG. 5B′ is a schematic view showing a burr formed between the first metal component and the second metal component as depicted in FIG. 5B after pressure welding;

FIG. 6A is a schematic view showing the workflow of the laser pressure welding machine as depicted in FIGS. 2 and 3 in accordance with a fourth embodiment of the present invention;

FIG. 6A′ is a schematic view showing a burr formed between the first metal component and the second metal component as depicted in FIG. 6A after pressure welding;

FIG. 6B is a schematic view showing the workflow of the laser pressure welding machine as depicted in FIGS. 2 and 3 in accordance with a fifth embodiment of the present invention;

FIG. 6B′ is a schematic view showing a burr formed between the first metal component and the second metal component as depicted in FIG. 6B after pressure welding;

FIG. 7A is a front view of a first metal component of a workpiece;

FIG. 7B is a cross-sectional side view of a workpiece manufactured by the laser pressure welding machine as depicted in FIGS. 2 and 3, wherein the workpiece includes the first metal component as depicted in FIG. 7A;

FIG. 7C is a front view of a second metal component of the workpiece as depicted in FIG. 7B;

FIG. 8 shows another workpiece manufactured by the laser pressure welding machine as depicted in FIGS. 2 and 3.

### DESCRIPTION OF THE PREFERRED EMBODIMENTS

The technical contents of the present invention will become apparent with the detailed description of preferred embodiments accompanied with the illustration of related drawings as follows. It is intended that the embodiments and figures disclosed herein are to be considered illustrative rather than restrictive. It is noteworthy that same numerals are used to represent same respective components in the drawings, and the drawings are purely schematic drawings only, but they do not reflect the actual geometric relation of the components.

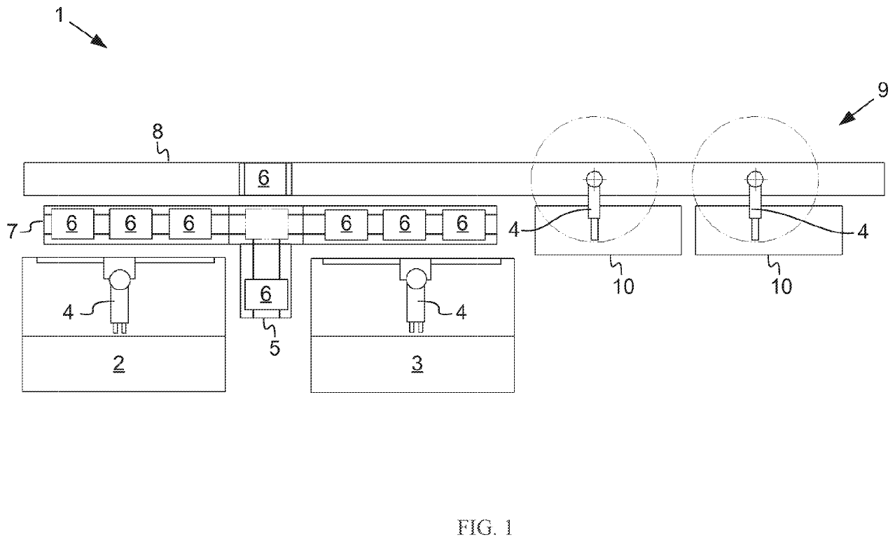

With reference to FIG. 1 for a schematic view of a production line 1, components in the production line 1 are manufactured into a finished product by tools, wherein the finished product will not be described in detail.

The production line 1 includes a component storage tank 2 for storing components and a tool storage tank 3 for storing tools. Each of the component storage tank 2 and the tool storage tank 3 is equipped with a robotic arm 4 for clamping and putting the corresponding components or tools into a tray 6 in a preparation station 5. The tray storage tank 7 has sufficient trays 6 for containing the components or tools, and a conveyor belt 8 is provided for convening the trays 6 to a machine tool queue 9 composed of a plurality of machine tools 10. These machine tools 10 jointly execute a production process. The aforementioned operation is completed by this production process. In other words, a workpiece is assembled by using the components and tools, wherein the workpiece will not be described in detail.

Each machine tool 10 in the machine tool queue 9 executes one or more intermediate steps of the production process. The robotic arm 4 grabs components and/or tools from the tray 6, and the machine tool 10 carries out the corresponding intermediate step to assemble the components. After the intermediate step is completed, the robotic arm 4 will put the semi-finished product or finished product or the tool no longer required into the corresponding trays 6, and then will send the semi-finished product to the next machine tool 10 to execute the next intermediate step or return them back into the component storage tank 2 or the tool storage tank 3. To distinguish the two terms “workpiece” and “component” clearly, the “component” is defined as a material sent to the machine tool 10 and waiting for manufacture, and it is a component coming from the component storage tank 2 or a semi-finished product coming from other machine tools from the previous intermediate step. The “workpiece” is defined as a component manufactured by a machine tool 10. Therefore, a workpiece leaving a machine tool 10 may be a component of another machine tool 10.

The control station not shown in FIG. 1 coordinates the conveying transfer of the material by using the robotic arm 4 and the tray 6.

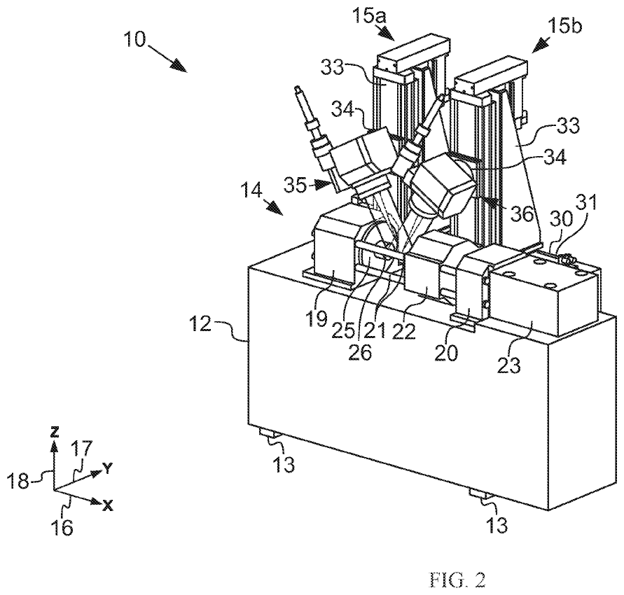

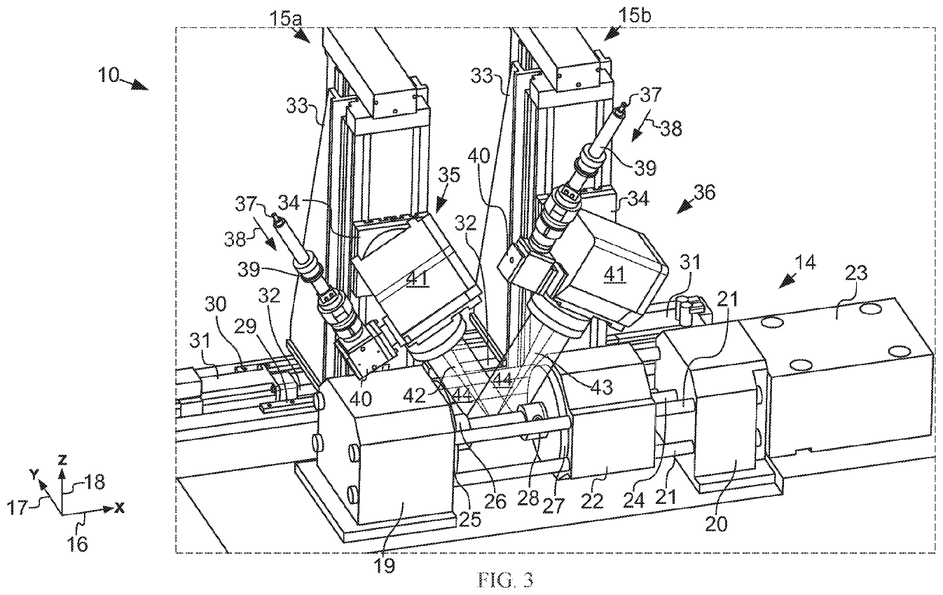

With reference to FIGS. 2 and 3 for the perspective view showing a laser pressure welding machine used as a machine tool 10 of a production line in accordance with an embodiment of the present invention, the machine tool is labeled as 10 in the laser pressure welding machine, and the processing component is a metal component.

The laser pressure welding machine 10 includes a frame 12 supported by a base 13. FIG. 2 does not show all bases 13. A vise 14 and a first support 15a and a second support 15b are driven by a motor and supported on the frame 12. To simplify the description, the laser pressure welding machine 10 is defined to be situated in a space with the X-direction 16, Y-direction 17, and Z-direction 18.

The vise 14 includes a first anchoring member 19 and a second anchoring member 20, wherein the first anchoring member 19 and the second anchoring member 20 are both fixed in position, and the second anchoring member 20 is separated with a specific distance from the first anchoring member 19 along the X-direction. Four guide rods 21 are connected between the first anchoring member 19 and the second anchoring member 20. To simplify the illustration by the figures, not all guide rods are shown or labeled in FIGS. 2 and 3. A slide bed 22 is slidably mounted to the guide rods 21 between the first anchoring member 19 and the second anchoring member 20, and the slide bed 22 is configured to be driven by a motor 23 and thereby move back and forth along the X-direction 16 between the first anchoring member 19 and the second anchoring member 20 though a lead screw 24, the lead screw 24 is threaded into the second anchoring member 20 through an inner thread (not shown in the figure). The vise 14 is provided for pressing the aforementioned component against one another in the X-direction 16.

In addition, a first support plate 25 having a first chuck 26 is mounted on the first anchoring member 19. The first support plate 25 faces the slide bed 22. Similarly, a second support plate 27 having a second chuck 28 is mounted on the slide bed 22. The second support plate 27 faces the first anchoring member 19. Each of the first chuck 26 and the second chuck 28 is capable of clamping a component through a known method. Two components, therefore, can be driven by the motor 23 to press against each other in the X-direction 16 when they are respectively clamped by the first chuck 26 and the second chuck 28.

The first support 15a and the second support 15b can be driven along a first guide rail 29 and a second guide rail 30 in the X-direction 16, wherein the second guide rail 30 is disposed at a rear position with respect to the first guide rail 29 in the Y-direction 17. The first support 15a and the second support 15b can be driven by separate motors 31 respectively to move back and forth along the first guide rail 29 and the second guide rail 30 in the X-direction 16 through lead screws 32 of the motors 31.

Each of the first support 15a and the second support 15b has a sliding system 33, on which a swing arm 34 capable of moving in the Z-direction 18 is installed. Each swing arm 34 can be moved in the Z-direction 18 by a respective driving system (which is not shown in FIGS. 2 and 3). The detailed description of the operating principle of the sliding system 33 is not relevant in the implementation of the embodiment of the present invention, thus will not be described further. The swing arm 34 of the first support 15a has a first laser beam generator 35 with a first laser device (not completely shown in FIGS. 2 and 3) installed thereon. Correspondingly, the swing arm 34 of the second support 15b has a second laser beam generator 36 with a second laser device (not completely shown in FIGS. 2 and 3) installed thereon. The swing arms 34 can, respectively, drive the first laser beam generator 35 and the second laser beam generator 36 to swing with respect to a swing axis that extends along the Y-direction 17. The swing arms 34 are driven to swing by the respective driving systems (not shown in FIGS. 2 and 3).

The first laser beam generator 35 and the second laser beam generator 36 will be described in detail below. For simplicity, the first laser beam generator 35 and the second laser beam generator 36 are labeled in FIG. 3 only. Each of the first laser beam generator 35 and the second laser beam generator 36 has a respective laser beam cable 37 which is drawn with break line in FIGS. 2 and 3, and the first laser beam generator 35 and the second laser beam generator 36, thereby, can generate a respective laser beam 38. Each of the laser beam 38 is collimated into a parallel beam by a respective collimator 39 and then guided by a respective polarizer 40 into a respective beam guiding device 41. The beam guiding device 41 of the first laser beam generator 35 outputs a first laser beam 42 generated from the corresponding laser beam 38, and the beam guiding device 41 of the second laser beam generator 36 outputs a second laser beam 43 generated from the corresponding laser beam 38. Each of the first laser beam 42 and second laser beam 43 can focus at any point within a respective scanning range 44 by adjustable mirrors and lenses (not shown in the figures). The specific working method is known and will not be described in detail.

The sliding system 33 and the swing arm 34 of the first support 15a are provided for roughly aligning the first laser beam generator 35 with the second chuck 28. A component clamped by the second chuck 28 may has a portion facing the first chuck 26 and being heated by the first laser beam 42 outputted by the first laser beam generator 35 to a temperature greater than its re-crystallization temperature. Likewise, the sliding system 33 and the swing arm 34 of the second support 15b are provided for roughly aligning the second laser beam generator 36 with the first chuck 26. A component clamped by the first chuck 26 may has a portion facing the second chuck 28 and being heated by the second laser beam 43 outputted from the second laser beam generator 36 to a temperature greater than its re-crystallization temperature. Subsequently, the heated portions of the two components are pressed tightly by the vise 14 and welded with each other. In FIGS. 2 and 3, two laser beam generators (i.e., the first laser beam generator 35 and the second laser beam generator 36) are used, which is a low-cost implementation method. For the reason of cost, the first support 15a and the first laser beam generator 35 may be used independently.

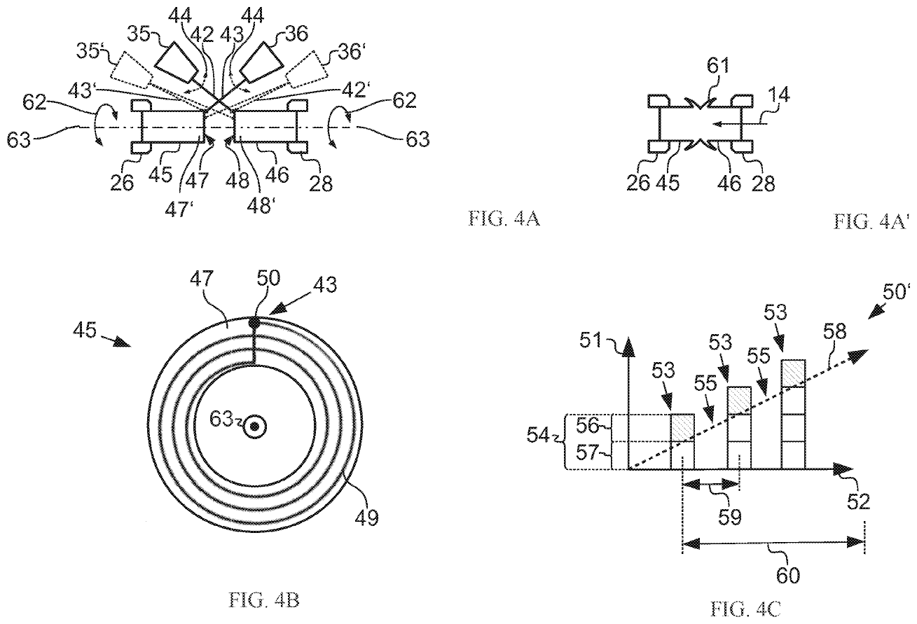

The basic operation of the laser pressure welding machine 10 has been described above, and more details with reference to FIG. 4A will be given below. FIG. 4A specifically shows a first metal component 45 clamped by the first chuck 26 and a second metal component 46 clamped by the second chuck 28. In the pressure welding method for join the first metal component 45 with the second metal component 46 as shown in FIG. 4A, the first laser beam 42 and the second laser beam 43 intersect each other at work. In other words, the first laser beam 42 heats the second metal component 46, while the second laser beam 43 heats the first metal component 45. The first metal component 45 has a first joining section 47′ with a first joining surface 47, and the second metal component 46 has a second joining section 48′ with a second joining surface 48. In FIG. 4A, the first joining surface 47 and the second joining surface 48 of the first metal component 45 and the second metal component 46 are heated directly and combined together by pressure.

To heat the first joining surface 47 and the second joining surface 48, the first laser beam generator 35 and the second laser beam generator 36 are aimed at the second metal component 46 and the first metal component 45 precisely and respectively. The precise aiming is intended for preventing the scanning range 44 of the first laser beam generator 35 from being overlapped with the scanning range 44 of the second laser beam generator 36 and preventing the undesired portions of the second metal component 46 and the first metal component 45 from being irradiated, so as to avoid the situation in which the first metal component 45 and the second metal component 46 oppositely blocks the first laser beam 42 and second laser beam 43. In FIG. 4A, the portion indicated by the dotted line and the numerals with an apostrophe show the positions where the first laser beam generator 35′ and the second laser beam generator 36′ are situated. At these positions, the first metal component 45 and the second metal component 46 block a portion of the scanning range 44 of the first laser beam 42′ emitted from the first laser beam generator 35′ and a portion of the scanning range 44 of the second laser beam 43′ emitted from the second laser beam generator 36′, respectively.

After the first laser beam generator 35 and the second laser beam generator 36 are positioned, the laser irradiation process starts. The second laser beam 43 emitted from the second laser beam generator 36 is precisely aimed at the first metal component 45, and the first laser beam 42 emitted from the first laser beam generator 35 is precisely aimed at the second metal component 46, whereby the second laser beam 43 and the first laser beam 42 are crossly projected onto the first joining surface 47 of the first metal component 45 and the second joining surface 48 of the second metal component 46, respectively. The first joining surface 47 of the first metal component 45 and the second joining surface 48 of the second metal component 46, thereby, can be heated to a temperature greater than their respective re-crystallization temperatures. The re-crystallization temperature depends on the materials. For example, steel has a re-crystallization temperature of approximately 600° C. to 700° C. based on different alloy compositions and structures. It is noteworthy that the heating temperature should not exceed the melting temperature of the first metal component 45 or the melting temperature of the second metal component 46, otherwise some portions of the first metal component 45 and the second metal component 46 will be damaged and the pressure welding process will be affected.

In order to heat the planes of the first joining surface 47 of the first metal component 45 and the second joining surface 48 of the second metal component 46 uniformly, the first laser beam generator 35 and the second laser beam generator 36 drives the first laser beam 42 and the second laser beam 43 to project on the second joining surface 48 and the first joining surface 47, respectively, along a curved path. In other words, the first laser beam 42 and the second laser beam 43 are brought to move with respect to the second joining surface 48 and the first joining surface 47, respectively. Alternatively, the aforementioned relative movement may be achieved by moving the first metal component 45 and the second metal component 46 as shown in FIG. 4A, wherein each of the first metal component 45 and the second metal component 46 performs a rotational motion 62 around a rotating axis 63. To achieve such movement of the first metal component 45 and the second metal component 46, the vise 14 of the laser pressure welding machine 10 as shown in FIGS. 2 and 3 is adjustable accordingly.

With reference to FIG. 4B for the aforementioned curved path which is a spiral curve 49, the spiral curve 49 is defined by scanning or projecting path of the second laser beam 43 on the first joining surface 47 of the first metal component 45. The second laser beam 43 is projected on the first joining surface 47 to heat the first joining surface 47 point by point. The second laser beam generator 36 is provided for driving the second laser beam 43 to move and carry out the heat point by point along the spiral curve 49.

The heating of a heated point 50 on the first joining surface 47 is analyzed and described below. The heating of the heated point 50 by the second laser beam 43 is divided into two stages as shown in FIG. 4C. FIG. 4C shows that the heat energy 51 of the heated point 50 changes with time 52. To show the correlation with the heating point 50, the numeral 50′ is used for labeling.

When the second laser beam 43 is projected at the heated point 50 on the first joining surface 47, the heated point 50 is in a heating stage 53, in which the heated point 50 is heated and has a heat gain 54 (also known as energy gain 54). FIG. 4C shows three heating stages 53, which means that the second laser beam 43 scans along the spiral curve 49 for three times and is projected at the heated point 50 for three times as well. The heat gain 54 shown in FIG. 4C is just labeled with a numeral in the first heating stage 53 only. When the second laser beam 43 is projected at points other than the heated point 50 on the spiral curve 49, the heated point 50 enters a cooling stage 55 and starts cooling off, which leads to a heat loss 56 (also known as energy loss 56). To heat the heated point 50 effectively, after the second laser beam 43 has scanned along the spiral curve 49 entirely, an energy difference 57 between the heat gain 54 and the heat loss 56 must be positive. Only this way can achieve an effective heating 58 on the first joining surface 47.The effective heating 58 is represented by a bold dotted arrow symbol in FIG. 4C.

The total duration of a heating stage 53 and a cooling stage 55 is hereinafter referred to as energy superimposition duration 59. The reciprocal of the energy superimposition duration 59 is defined as an energy superimposition frequency which indicates the moving speed of the second laser beam 43 along the spiral curve 49. The total duration of all heating stages 53 and all cooling stages 55 is defined as a heating time 60.

When the heat energy 51 at all points of the spiral curve 49 on the first joining surface 47 has a temperature greater than the re-crystallization temperature of the first metal component 45, the heating time 60 is adequate. The warming or heating method of the second joining surface 48 is the same as that of the first joining surface 47.

When the first joining surface 47 of the first metal component 45 and the second joining surface 48 of the second metal component 46 are heated to a temperature greater than their re-crystallization temperature, the first metal component 45 and the second metal component 46 are pressed against each other by the vise 14, until the first metal component 45 and the second metal component 46 are cooled to a temperature below the re-crystallization temperature. As shown in FIG. 4A′, a burr 61 may now be formed at a first joining section 47′ of the first metal component 45 and a second joining section 48′ of the second metal component 46; however, it can be removed by a process such as a cutting process.

After the first metal component 45 and the second metal component 46 are mechanically coupled to each other, the first metal component 45 and the second metal component 46 can be removed from the vise 14 for further manufacture (such as being sent to the production line 1 for further manufacture).

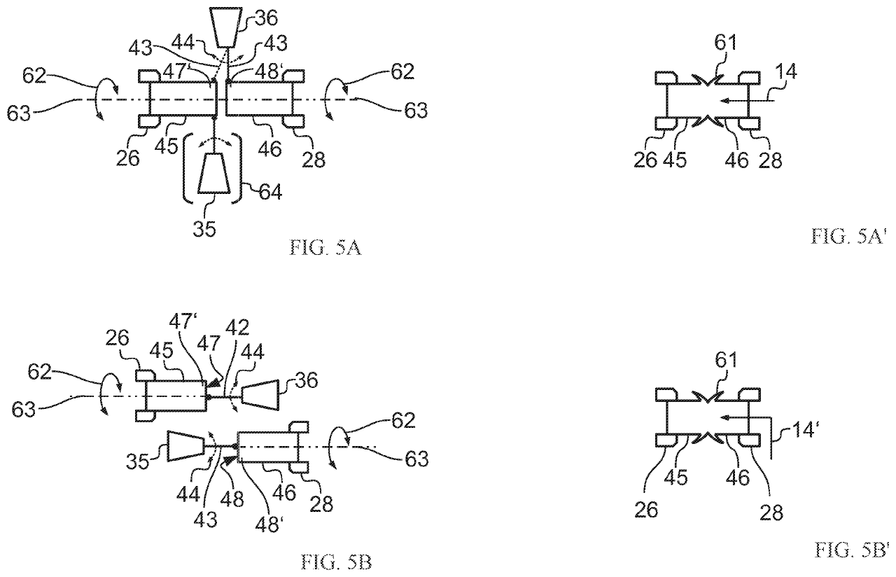

FIG. 5A shows another embodiment of heating the first joining surface 47 of the first metal component 45 and the second joining surface 48 of the second metal component 46. For the sake of clarity, not all components in FIG. 5A are labeled with their respective numerals. Either one of the first laser beam generator 35 or the second laser beam generator 36 can be selectively omitted, in this figure the first laser beam generator 35 labeled with a bracket 64 is to be omitted.

Firstly, the operating method of using the first laser beam generator 35 to heat the first metal component 45 and the second laser beam generator 36 to heat the second metal component 46 is described below.

In an embodiment as shown in FIG. 5A, the first laser beam 42 and the second laser beam 43 are not projected onto the first joining surface 47 and the second joining surface 48 directly, but projected onto the first joining surface 47 and the second joining surface 48 indirectly through a side surface of the first joining section 47′ of the first metal component 45 and a side surface of the second joining section 48′ of the second metal component 46. With respect to the rotating axis 63, the first laser beam 42 and the second laser beam 43 are aimed precisely at corresponding portions of the side surfaces of the first metal component 45 and the second metal component 46 in an inward radial direction, respectively. Unlike the embodiment as shown in FIG. 4A, the first laser beam 42 and the second laser beam 43 are no longer crossly projected onto the first metal component 45 and the second metal component 46.

In the embodiment as shown in FIG. 5A, the first joining surface 47 and the second joining surface 48 are not heated by a direct projection of the first laser beam 42 and the second laser beam 43. More specifically, the first laser beam 42 is projected onto the side surface of the first joining section 47′ of the first metal component 45 to indirectly heat the first joining surface 47 to a temperature greater than its re-crystallization temperature. By using the same method, the second laser beam 43 is projected indirectly on and heat the second joining surface 48 to a temperature greater than its re-crystallization temperature. As shown in FIG. 5A′, the subsequent process can be completed by using the same method as illustrated in FIG. 4A′.

In order to omit the first laser beam generator 35 labeled with the bracket 64, the second laser beam generator 36 can be installed at a position between the first joining section 47′ and the second joining section 48′, and the second laser beam 43 can swing back and forth between the first joining section 47′ and the second joining section 48′. As indicated by the dotted line in FIG. 5A, the second laser beam 43 therefore can also aimed at and projected on the first joining section 47′.

In an embodiment as shown in FIG. 5B, even if the rotating axis 63 of the first metal component 45 does not align with the rotating axis of the second metal component 46, the first joining section 47′ of the first metal component 45 and the second joining section 48′ of the second metal component 46 can be heated. To press the first metal component 45 against the second metal component 46, it is necessary to push them precisely on a straight line, and the operation cannot be done by simply using the vise 14. Therefore, an actuator must be selected and used for placing the first metal component 45 and the second metal component 46 on an axis before the first metal component 45 and the second metal component 46 are pressed against each other. The actuator is labeled with the numeral 14′ in FIG. 5B, and the subsequent process can be completed by the same method as illustrated in FIG. 4A′.

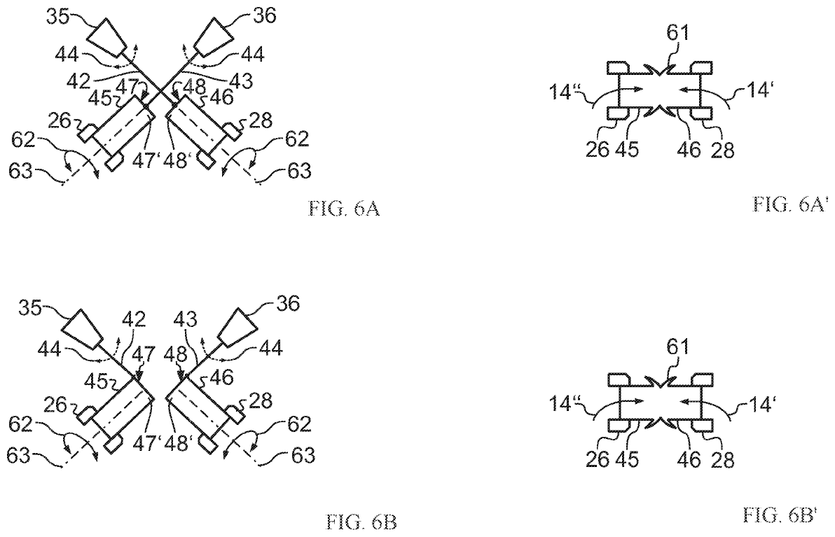

FIGS. 6A and 6B show another embodiment of heating the first joining section 47′ of the first metal component 45 and the second joining section 48′ of the second metal component 46. An angle is defined between the rotating axis 63 of the first metal component 45 and the rotating axis 63 of the second metal component 46. In this embodiment, the first metal component 45 and the second metal component 46 also must be placed on an axis before being pressed against each other. In addition to the actuator 14′ used for moving the second metal component 46 as shown in FIG. 5A, a driver 14″ for moving the first metal component 45 should be added to improve efficiency. Furthermore, as shown in FIGS. 6A′ and 6B′, the subsequent process can be completed by the same method as illustrated in FIG. 4A′.

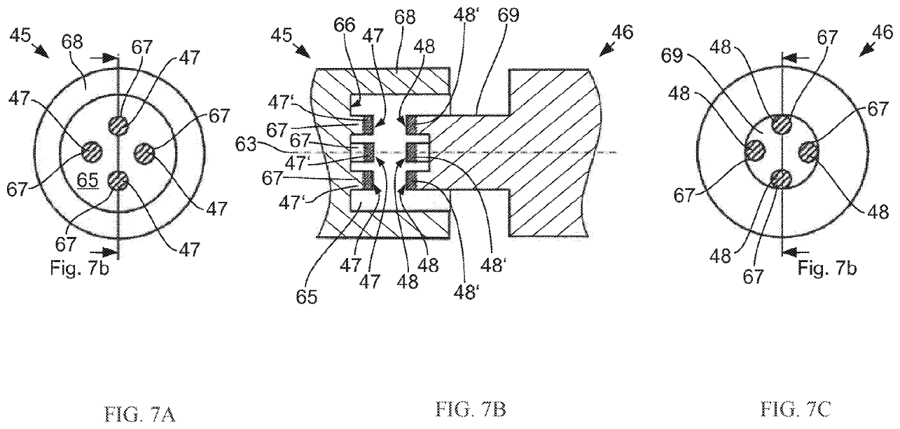

For the detailed description of the advantages of the laser pressure welding machine 10, the first metal component 45 and second metal component 46 are shown for exemplary purpose in FIGS. 7A to 7C. The first metal component 45 and the second metal component 46 can be joined together without any problem using the aforementioned pressure welding method, while they cannot be joined together using the conventional pressure welding method.

The first metal component 45 has a cavity 65 formed on a front side thereof, and four raised portions 67 are disposed on a bottom 66 of the cavity 65. The first joining surface 47 of the first metal component 45 is distributed on these four raised portions 67. The four raised portions 67 are surrounded by a periphery wall 68 of the first metal component 45.

The second metal component 46 has a projection 69 disposed on a front side thereof, and four raised portions 67′ are disposed on a top 66′ of the projections 69. The second joining surface 48 of the second metal component 46 is distributed on the four raised portions 67′. The raised portions 67 of the first metal component 45 and the raised portions 67′ of the second metal component 46 are distributed in a specific pattern, so that when the projection 69 is inserted in an axial direction into the cavity 65, the raised portions 67 of the first metal component 45 and the raised portions 67′ of the second metal component 46 are aligned precisely with each other and pressed tightly with each other.

In the conventional pressure welding technology using the effect of electromagnetic field, the periphery wall 68 may cause a shielding effect on the electromagnetic field and, therefore, prohibits the heating of the first joining surface 47 in the cavity 65. In the conventional pressure welding technology using frictional heat for the operation, the first joining surface 47 and second joining surface 48 cannot be heated, either, due to structural limitations.

However, there is no problem of using the first laser beam 42 and the second laser beam 43 for heating, since the laser beams can be projected into the cavity 65 and, thereby, heat the joining surfaces separately. In the aforementioned method of projecting the laser beams to heat the first joining surface 47 and the second joining surface 48, there is no particular limitation on the structure and material of the first metal component 45 and the second metal component 46 for the pressure welding.

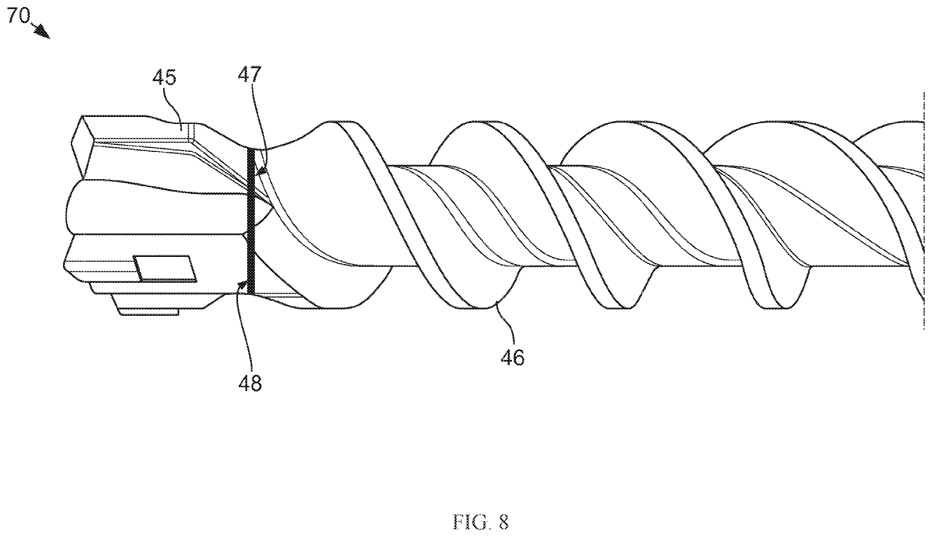

The pressure welding method of using the first laser beam 42 and the second laser beam 43 to heat the first joining surface 47 and the second joining surface 48 can be used in many areas. FIG. 8 shows the principle of manufacturing a workpiece (e.g., a drill bit 70 as shown in FIG. 8) by the laser pressure welding manufacturing method.

The drill bit 70 includes a drill bit top (which can be referred as the first metal component 45) and a drill bit thread (which can be referred as the second metal component 46). Since the drill bit top 45 and the drill bit thread 46 generally come with different shapes according to requirements, they are usually made of different materials.

The aforementioned pressure welding method of using the first laser beam 42 and the second laser beam 43 is very suitable for joining two materials, which have completely different re-crystallization temperatures, together, because the first laser beam 42 and the second laser beam 43 do not affect each other and can heat the first joining surface 47 and the second joining surface 48 independently. For example, the drill bit top 45 and the drill bit thread 46 are made of hard sintered material and soft steel, respectively, which cannot be joined together by the conventional pressure welding method.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A laser pressure welding method for manufacturing a workpiece, comprising the steps of:
a) projecting a first laser beam onto a first joining section of a first metal component to heat the first joining surface to a temperature between a re-crystallization temperature and a melting temperature of the first metal component;
b) projecting a second laser beam onto a second joining section of a second metal component to heat the second joining surface to a temperature between a re-crystallization temperature and a melting temperature of the second metal component; and
c) pressing the first joining surface of the first metal component against the second joining surface of the second metal component tightly until the first joining surface of the first metal component and the second joining surface of the second metal component are cooled to a temperature below their re-crystallization temperature, wherein the first laser beam and the second laser beam are projected onto the first joining section and the second joining section respectively and simultaneously, wherein when the first joining section and the second joining section are projected with the first laser beam and the second laser beam respectively, surface normal of the first joining surface is opposite to surface normal of the second joining surface, and the first joining surface and the second joining surface share a common axis, and the first laser beam and the surface normal of the first joining surface define a specific angle therebetween while the second laser beam and the surface normal of the second joining surface define a specific angle therebetween.

2. The laser pressure welding method according to claim 1, wherein the first laser beam used for heating the first joining section moves along a spiral curve on the first joining section to scan the first joining section with a predetermined laser intensity.

3. The laser pressure welding method according to claim 2, wherein the first laser beam moves along the spiral curve periodically with an energy superimposition frequency.

4. The laser pressure welding method according to claim 3, wherein each heated point along the spiral curve on the first joining section has a heat gain during a heating stage and a heat loss during a cooling stage, and the energy superimposition frequency is preset such that the heat gain is greater than the heat loss, wherein the heated point is in the heating stage when the first laser beam is projected thereon, and otherwise the heated point is in the cooling stage.
